(19) United States
(12) Patent Application Publication
(10) Pub. No.: US 2004/0232595 A1
(43) Pub. Date: Nov. 25, 2004

(54) Apparatus, forming means and methods for forming sheet material

(76) Inventor: Andrea Bartoli, Reggio Emilia (IT)

Correspondence Address: NIXON & VANDERHYE, PC, 1100 N GLEBE ROAD, 8TH FLOOR, ARLINGTON, VA, 22201-4714, US

(21) Appl. No.: 10/481,462

(22) PCT Filed: Jun. 18, 2002
(86) PCT No.: PCT/IB02/02243

(30) Foreign Application Priority Data
Jun. 19, 2001 (IT) MO01A000124
Jun. 6, 2002 (IT) MO02A000155

(51) Int. Cl. B29C 51/10; B29C 55/02

(52) U.S. Cl. 264/289.3; 264/544; 264/291; 264/320; 264/322; 425/122; 425/128; 425/406

(57) ABSTRACT

An apparatus for forming sheet material (2), in particular sheet material based on natural fibers, comprises in sequence deformability promoting means (5) suitable for making said sheet material more easily deformable (2), forming means (9, 10, 11, 16a, 101a101b) suitable for deforming said sheet material (2); said deformability promoting means is deformability promoting material means (5). Forming means for shaping sheet material (2) comprises fluid forming means suitable for shaping portions of said sheet material (2), and a flow-inhibiting means (17, 116; 116a, 116b) suitable for preventing said fluid forming mean flowing through said sheet material (2). A method for forming sheet material (2), in particular sheet material based on natural fibers, comprises in sequence dispensing deformability promoting means suitable for making said sheet material more easily deformable (2), and shaping portions of said sheet material (2), said dispensing deformability promoting means comprising dispensing deformability promoting material means (5). A method for shaping sheet material (2) comprises forming portions of said sheet material (2) through fluid forming means, and further comprises interposing between said fluid forming means and said sheet material (2) a flow-inhibiting means (17, 116; 116a, 116b) suitable for preventing said fluid forming means from flowing through said sheet material (2).

The invention relates to apparatus, forming means and methods for forming sheet material. Examples of sheet materials that can be formed using the apparatus, the forming means and the methods described below are materials based on natural fibres and plastic materials that can be used for containers for packaging in general, trays and cups for food products, blisters for pharmaceutical use and the like.

The materials based on natural fibres are materials obtained from wooden fibres, cellulose or other materials such as the prior-art material known by the trademark “mould paper”. For environmental reasons, said materials are becoming popular with consumers and packaging professionals; due to their composition said material can in fact be more easily recycled or disposed of than the plastic materials traditionally used in packaging industry.

Sheet materials are currently formed according to two thermoforming techniques, namely the vertical forming technique and the horizontal forming technique.

In vertical forming machines two strips of sheet material, suitable for creating two opposite parts of the containers, are passed through one or more pre-heating stations that heat them to a temperature that is close to the softening temperature of the plastic of which they are made.

Subsequently, at a sealing station the two strips are sealed along a preset profile corresponding to the edge of the container to be formed. This profile is interrupted at an opening through which, at one or more subsequent forming stations, pressurised air is injected suitable for inflating the sheet material, which thus dilates in order to deform according to the geometry of a mould within which the sheet material is inserted into the forming station.

The pressurised air that causes the sheet material to swell is injected through appropriate conduits, each conduit being bounded by a first wall, defined in a half-mould, and by a second wall defined in a second half-mould, said first half-mould and second half-mould being movable towards each other to close onto the sheet material.

The opening through which the pressurised air has been injected is subsequently used to fill the container formed with the material to be packaged, and is finally closed.

Machines of this type enable containers to be obtained that are particularly suitable for being filled with fluid or pasty products but are not suitable for the production of containers formed by a pair of shells that have to be associated to each other after an object, typically consisting of a solid product, has been placed between them.

Furthermore, as in this type of machine the forming action is performed only by the pressurised air that deforms the heated material, with this system only containers with a limited depth can be obtained because the action of the air on its own is not sufficient to deform the sheet material beyond a certain limit.

This drawback is particularly serious if the vertical forming machines are used to thermoform materials based on natural fibres, that have more limited stretching and deformability properties than plastic films. For this reason, containers in natural-fibre materials with extremely limited depths can be obtained with vertical forming machines.

According to the horizontal forming technique, a sheet material is pre-heated to a temperature that is near the softening temperature and, at a-subsequent forming station, is shaped by means of a punch that is engaged in a matrix so as to form the sheet material according to the desired geometry. The mechanical action of forming by the punch and matrix is accompanied by the action of the pneumatic means that is suitable for ensuring that the sheet material adheres to the punch and matrix in a regular manner and without wrinkles.

The horizontal forming technique enables containers of significant depth to be obtained, but subjects the material to be formed to high stress, which is the greater the greater the set deformation.

It is difficult for sheet materials to bear this stress.

This drawback is particularly pronounced in the case of materials based on natural fibres, which tend to break, or to defibrate, under the combined action of the punch and matrix, such materials being, as already mentioned, less deformable and resilient than plastic films.

An object of the invention is to improve the apparatuses, the forming means and the prior-art methods for forming sheet material.

A further object of the invention is to provide apparatuses, forming means and methods for forming sheet material even according to complicated shapes that have significant depth, without subjecting the material to excessive mechanical stress.

A further object of the invention is to provide apparatuses, forming means and methods suitable for forming sheet material thereby obtaining qualitatively good results and limiting, or even eliminating, the risk of causing damage or breakages.

A still further object of the invention is to obtain apparatuses and forming means suitable for forming sheet materials that are constructionally simple and have significant effectiveness.

In a first aspect of the invention, an apparatus for forming sheet material is provided, in particular sheet material based on natural fibres, comprising in sequence deformability promoting means suitable for making said sheet material more easily deformable, forming means suitable for deforming said sheet material, characterised in that said deformability promoting means is deformability promoting material means.

In a preferred embodiment, the deformability promoting material means comprises liquid means, particularly water.

In a further preferred embodiment, the forming means comprises mechanical forming means suitable for deforming the sheet material mechanically, and a fluid forming means.

Advantageously, the fluid forming means comprises pneumatic forming means suitable for forming the sheet material pneumatically.

Owing to this aspect of the invention, it is possible to form sheet material, particularly sheet material based on natural fibres, without damage and tearing occurring.

In fact, the deformability promoting material means softens the sheet material, by conferring plasticity to the fibrous mass constituting said sheet material and by facilitating the work of the mechanical forming means, which, helped by the fluid forming means, can conform the sheet material into the required shape.

Said shape may even be very complex and be distinguished by significant depth, because owing to the plasticity conferred by the deformability promoting material means the sheet material can be deformed extremely easily.

In a further advantageous embodiment, flow-inhibiting means are further provided suitable for inhibiting the fluid-forming means from flowing through the sheet material.

Advantageously, the flow-inhibiting means comprises a membrane means preferably based on plastic material.

This enables the fluid forming means to perform its task successfully even when the sheet material to be formed has a certain porosity, as is the case with materials based on natural fibres.

In a further advantageous embodiment, evacuating means are provided for evacuating the deformability promoting material means, said evacuating means is suitable for removing from the sheet material the deformability promoting material means, after the latter has performed its task.

Advantageously, the evacuating means comprises heating means suitable for heating the sheet material so as to cause the evaporation of deformability promoting material means.

Owing to the evacuating means the sheet material, after being formed by the forming means, is able to regain its original consistency and with it all the mechanical resistance and stiffness properties that distinguishes it, thereby making it suitable for its intended use.

In a second aspect of the invention, forming means for shaping sheet material is provided, comprising fluid forming means suitable for forming portions of said sheet material, characterised in that flow-inhibiting means is further provided suitable for preventing said fluid forming means from flowing through said sheet material.

In a preferred embodiment, the flow-inhibiting means comprises a membrane means.

Advantageously, the membrane means is substantially impermeable to the fluid forming means. Further advantageously, the membrane means is made from plastic material.

In a further preferred embodiment, the fluid forming means comprises a pneumatic forming means.

Advantageously, the forming means comprises mechanical forming means cooperating with the fluid forming means.

Owing to this aspect of the invention, it is possible to form relatively porous sheet material, such as materials based on natural fibres, thereby obtaining qualitatively good results, because the flow-inhibiting means allowing fluid forming means to be used which ensures that the sheet material adheres precisely to the mechanical forming means. This prevents the formation of wrinkles and other irregularities.

In one advantageous embodiment, the forming means comprises at least one body crossed by conduit means suitable for enabling the passage of the fluid forming means, said conduit means ending in opening means arranged at forming zone means of said at least one body, said forming zone means being associated with said membrane means, which can be deformed by said fluid forming means.

In a preferred embodiment, the conduit means is defined by walls that are fully contained in said at least one body.

In another preferred embodiment, said opening means faces said membrane means and faces the sheet material to be deformed.

In a further preferred embodiment, said at least one body comprises a first body in which hollow means is obtained inside which openings of said opening means are defined.

Advantageously, said membrane means is fixed peripherally to the first body.

In a still another preferred embodiment, said at least one body comprises a further body in which cavity means is defined which acts as matrix means suitable for receiving the sheet material during forming.

Advantageously, inside the cavity means further openings of said opening means are obtained.

In a further preferred embodiment, the first body and the further body are movable towards and away from one another between a rest position, in which the first body and the further body are mutually spaced in such a way that the sheet material can be placed between them, and an operating position in which the first body and the further body come into contact with each other to close onto the sheet material.

When the first body and the further body are in the operating position the fluid forming means is injected through said openings and interacts with the membrane means to deform the sheet material.

Simultaneously, further fluid forming means is aspirated through further openings so as to be extracted from the cavity means.

In this way, the fluid forming means performs a dual forming action, on the one side it is pressurised and, through the membrane means, presses the sheet material inside the cavity means and on the other side it is aspirated to create a vacuum that attracts the sheet material towards the walls that define said cavity means.

In said manner, sheet materials can be advantageously formed that are porous and therefore permeable to the fluid forming means, such as for example, materials based on natural fibres. The membrane means, in fact, acts as a barrier to the fluid forming means: the fluid forming means in fact deforms the membrane means, which in turn deforms the sheet material.

Owing to this preferred embodiment of the invention, forming means for forming a sheet material can be obtained that enables containers of a given depth to be obtained even without the use of a deforming punch or of any mechanical forming means.

In this way the sheet material is subjected to more limited stress, which allows the risk of damage to or breakage of the sheet material to be drastically reduced.

In a third aspect of this invention, a method for forming sheet material, in particular sheet material based on natural fibres, is provided comprising in sequence dispensing deformability promoting means suitable for making said sheet material more easily deformable and shaping portions of said sheet material, characterised in that said dispensing deformability promoting means comprises dispensing deformability promoting material means.

In a preferred embodiment, said dispensing deformability promoting material means comprises dispensing liquid means, particularly water.

Owing to this aspect of the invention, it is possible to obtain a method for forming sheet materials even according to complicated shapes. In fact, the deformability promoting material means softens the sheet material and gives it such a plasticity that enables deformation thereof into a wide range of shapes, also comprising deep recesses, without damage and breakages.

In a preferred embodiment, said shaping comprises mechanically shaping the sheet material, using mechanical forming means.

In another preferred embodiment, said shaping comprises using fluid forming means, preferably pneumatic forming means.

In a further preferred embodiment, the method further comprises interposing between the fluid forming means and the sheet material flow-inhibiting means suitable for preventing the fluid forming means from flowing through said material.

Advantageously, said interposing flow-inhibiting means comprises interposing membrane means.

Further advantageously, said shaping comprises deforming the membrane means through punch means, the membrane means wrapping at least one active surface of the punch means.

Owing to the membrane means, the sheet material, even if it is relatively porous, when subjected to the fluid forming means, adheres to the punch means, so preventing the formation of wrinkles or other defects and ensuring high-quality final results.

In a further preferred embodiment, the method further comprises evacuating the deformability promoting material means.

Advantageously, said evacuating comprises heating the sheet material, so as to evaporate the deformability promoting material means.

In this way, the sheet material can, after being deformed into the desired shape, regain its consistency and its physical and mechanical properties.

In a fourth aspect of the invention, a method for shaping sheet material is provided, comprising forming portions of said sheet material through fluid forming means, characterised in that it further comprises interposing between said fluid forming means and said sheet material flow-inhibiting means suitable for preventing said fluid forming means from flowing through said sheet material.

In a preferred embodiment, said interposing flow-inhibiting means comprises interposing membrane means, preferably made from plastic material.

In another preferred embodiment, said forming comprises forming the sheet material through pneumatic forming means.

In a further preferred embodiment, said forming further comprises forming the sheet material through mechanical forming means.

Owing to this aspect of the invention, and in particular owing to the interposing of the membrane means, it is possible to use fluid forming means to shape even relatively porous sheet material, the fluid forming means ensuring that the sheet material to be formed is arranged according to a regular configuration free of wrinkles.

High-quality final results can thus be obtained.

The invention may be better understood and carried out with reference to the accompanying drawings, which show some exemplifying and not limiting embodiments thereof, in which:

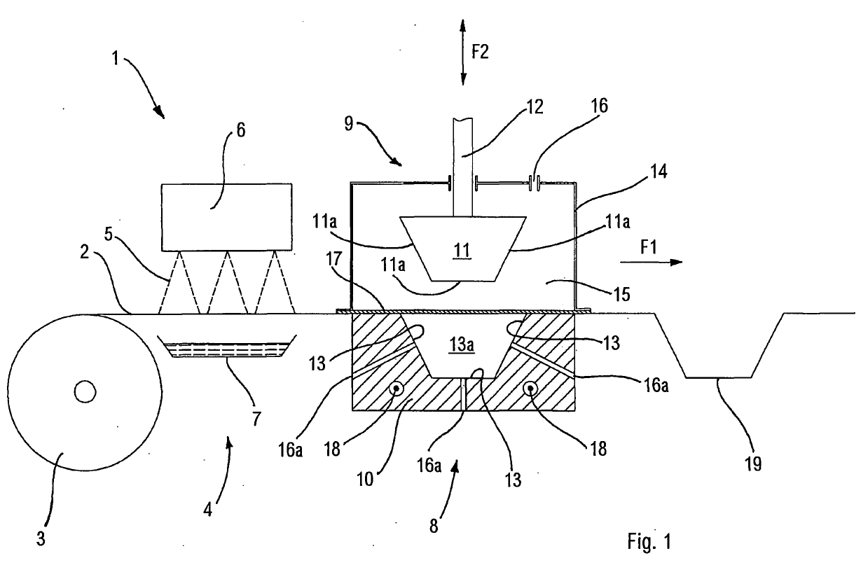

FIG. 1 is a schematic front view of an apparatus for forming sheet material according to the invention;

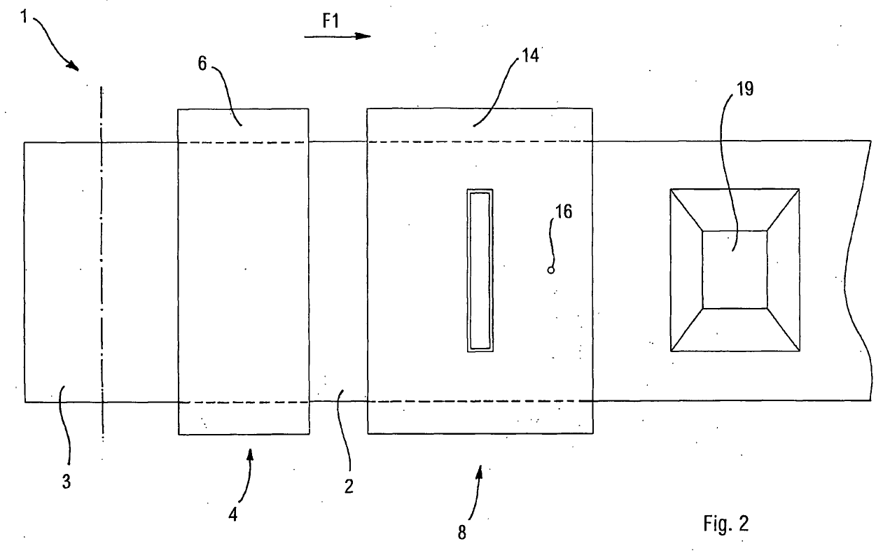

FIG. 2 is a schematic plan view of the apparatus in FIG. 1;

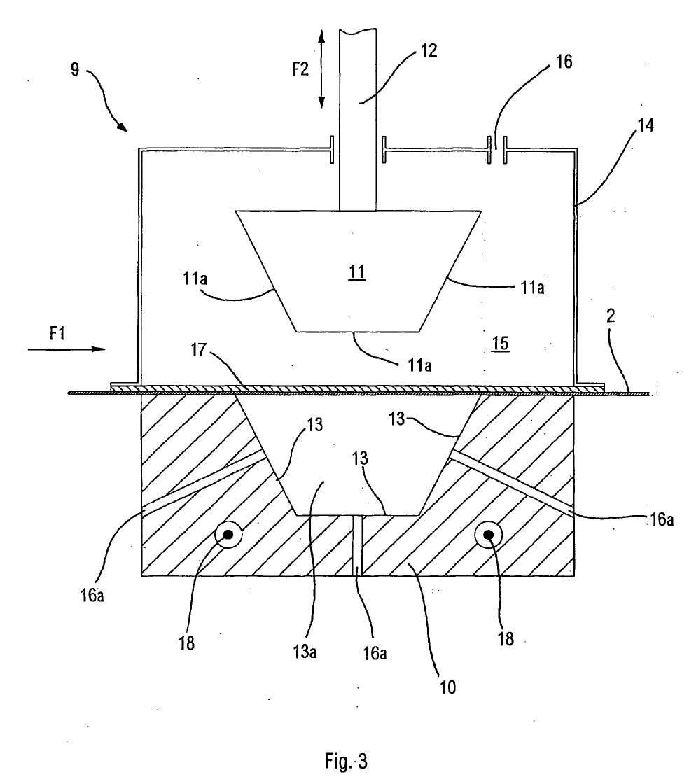

FIG. 3 is a schematic and enlarged section of the forming means of the apparatus in FIG. 1;

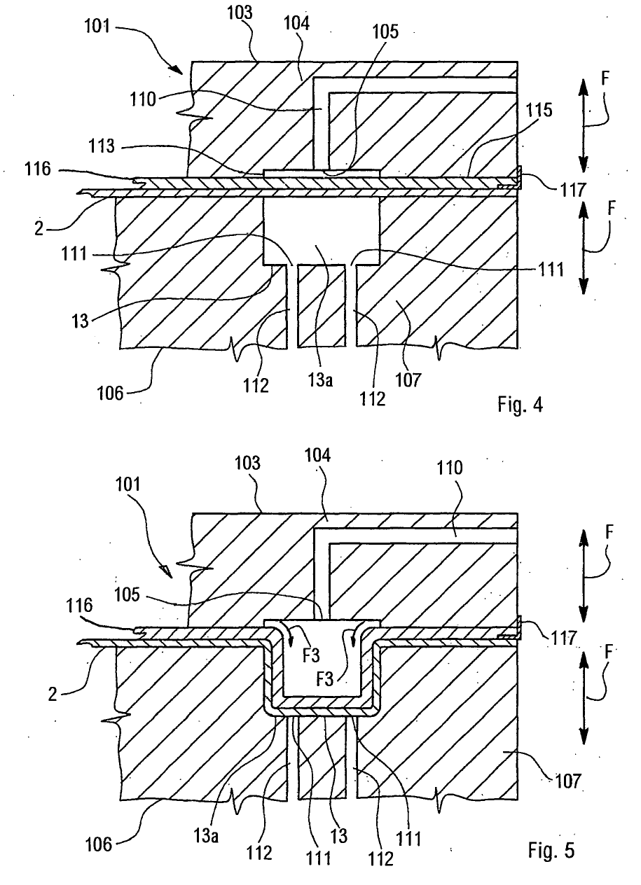

FIG. 4 is a section taken along a vertical plane of forming means according to the invention associated with still not deformed sheet material;

FIG. 5 is a section like the one of FIG. 4, showing the forming means during forming of the sheet material;

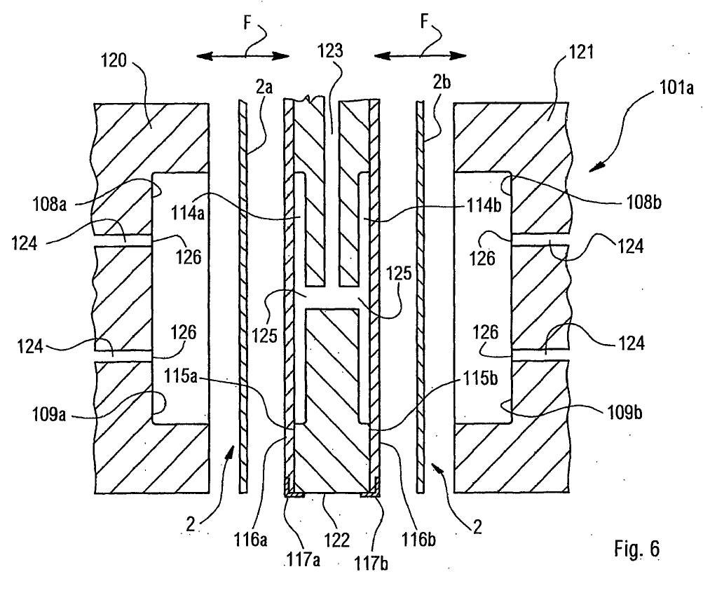

FIG. 6 is a section like the one of FIG. 4, showing a variation of the forming means arranged to simultaneously form a pair of sheet-material films;

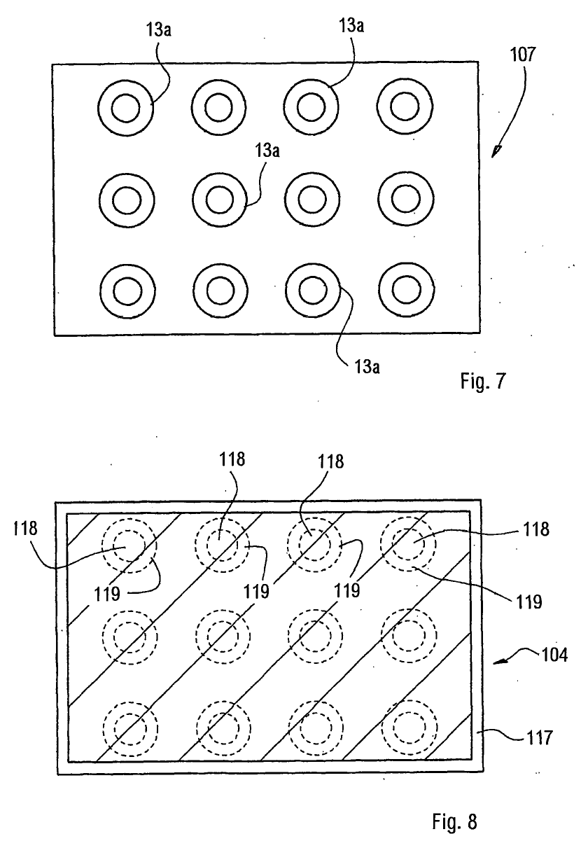

FIG. 7 is a plan view of a half-mould of a further variation of the forming means, in which a plurality of cavities is obtained suitable for forming respective container shells from a single film of sheet material;

FIG. 8 is a plan view of a further half-mould, that can be associated with the half-mould of FIG. 7, provided with deformable membrane means;

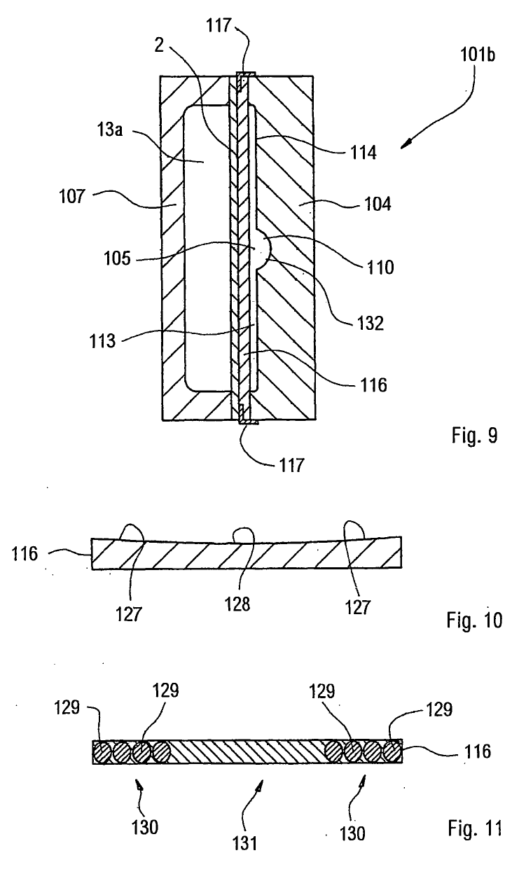

FIG. 9 is a section taken along a horizontal plane of a still another variation of the forming means according to the invention;

FIG. 10 is a section taken along a vertical plane of a preferred embodiment of the membrane means;

FIG. 11 is a section like the one of FIG. 10, showing a further preferred embodiment of the membrane means.

FIGS. 1 and 2 show an apparatus 1 for forming sheet material 2, for example, material based on natural fibres, unwound from a reel 3 by an unwinding means not shown and indexed in the direction indicated by arrow F1 along a conveying and processing line.

The sheet material 2 passes through a humidification station 4, in which it is humidified with a liquid substance 5 applied by means of a dispensing device 6 comprising, for example, a set of spray nozzles, the excesses of said liquid substance 5 being collected in a tray 7 positioned underneath the sheet material 2. As an alternative to the spray nozzles, the liquid substance 5 can be applied by any prior-art dispensing device, for example, by placing the sheet material 2 in an appropriate bath or by dampening it by means of sponge rollers impregnated with the liquid substance 5, or with something else.

Preferably, the liquid substance 5 mainly consists of water that penetrates the sheet material 2 and thereby acts as deformability promoting means, in other words softens the sheet material 2 by making pasty the fibres thereof so as to give the material 2 a high degree of plasticity which enables it to be easily shaped according to a preset geometry.

The liquid substance 5 may also contain, in a solution or in dispersed form, additives that can give the material 2, once returned to its original state after forming, particular properties: for example additives suitable for increasing the stiffness of the material 2 such as starch, or proofing additives suitable for improving the barrier properties of the material 2, or still again substances suitable for sterilising the material 2, for example H₂0₂ or special powders.

After being humidified and then reaching a high level of deformability, the material 2 enters a forming station 8, comprising a mould 9 suitable for forming the material 2 according to the required shape. The mould 9 is provided with mechanical forming means, comprising a matrix 10 suitable for receiving a portion of material 2 after the latter has been shaped, and a punch 11 suitable for shaping said portion of material 2. The punch 11 is fixed to a rod 12 translatable in the direction indicated by the arrow F2 between a free position, such as the one shown by FIG. 1, in which the punch 11 is located above the undeformed material 2, and a work position, not shown, in which the punch 11 deforms the material 2 by pushing it into contact with the walls 13 of a cavity 13a with which the matrix 10 is provided.

The mould 9 is enclosed at the top in a bell 14, inside which a tight chamber 15 is obtained. Furthermore, fluid forming means is associated with the mould 9, which fluid forming means may also comprise pneumatic fluid-forming means, for example a flow of pressurised air that enters the chamber 15 through a hole 16 made in its top wall, or any other appropriate fluid. The air flow promotes the deformation of the sheet material 2, by pushing it point by point against the walls 13 of the cavity 13a, possibly passing through holes, not shown, that are made in the punch 11.

The pneumatic forming means further comprises air aspirated through a plurality of extracting conduits 16a, which extracting conduits 16a are made in the matrix 10, and are suitable for evacuating air from the cavity 13a by means of an air aspiration or vacuum-creating device that is not shown.

In this way, it is certain that the portion of material 2 to be deformed is arranged in a regular manner between the punch 11 and the matrix 10, without causing wrinkles or other defects.

In order to enable the pneumatic forming means to perform its action in the manner described above, as shown in detail in FIG. 3, between the sheet material 2 and the bell 15 flow-inhibiting means is interposed comprising a membrane 17 that is substantially impermeable to the air flow or to other fluids. The membrane 17 is fixed to the bell 15 so as to close said bell 15 and is preferably made of plastic material, for example, polyurethane or silicone resin; said plastic material is provided with a thin thickness and marked elastic properties so as to be deformed under the action of the punch 11 and to then return to an undeformed configuration when the punch 11 lifts up from the matrix 10 to go to its free position.

To form the sheet material 2, the punch 11 descends to the work position and deforms the membrane 17, which wraps one or more active surfaces 11a of the punch 11. The flow of pressurised air that enters the chamber 15 through the hole 16, together with the mechanical action of the punch 11, shapes the membrane 17 and with it the material 2. The membrane 17, which push the sheet material 2 to be formed, is promoted to adhere to the cavity 13a of the matrix 10 by the air aspirated through the extracting conduits 16a; in this way the material 2 is induced to take on precisely, point by point, the form of the cavity 13a. The membrane 17 enables the air flow, whether the air flow be pressurised air sent from the chamber 15 or air aspirated through the conduits 16a of the matrix 10, to perform its forming action even when the material 2 to be formed is a porous material, and as such the air flow would tend to traverse it without changing the form thereof. In fact, by interposing itself between the material 2 and the air flow, the membrane 17 acts as a barrier to the latter and by becoming deformed, applies pressure point by point to the material 2.

In the forming station 8 evacuation means is further provided suitable for removing the liquid substance 5 from the material 2 after the latter has been formed. In particular, the evacuating means comprises one or more heating elements, for example resistances 18, suitable for increasing the temperature of the mould 9, and in particular of the matrix 10, to promote the evaporation of the liquid substance 5. By eliminating the liquid substance 5 from the material 2, said material 2 regains consistency and stiffness and maintains the form that it was given inside the mould 9.

The heating elements furthermore acts as activating means for activating any possible additives contained in the liquid substance 5, so allowing said additives to react to perform their function. After forming, opening means for opening the mould 9 is provided, not shown, which enables the material 2 that has been shaped at preset regions 19 to leave the mould 9 and be conveyed towards subsequent stations, for example filling, shearing, and other stations.

The materials based on natural fibres can also be coupled with different types of material, for example film made of plastic material suitable for giving the materials based on natural fibres certain properties, for example barrier properties, or sealing properties, or smoothness properties or other properties.

To process the coupled materials, an embodiment of the apparatus according to the invention that is not shown is particularly suitable. Said embodiment provides, upstream the forming station 8, a pre-heating station in which the sheet material is heated to a high temperature so as to cause the softening of the film in plastic material that is coupled with the material based on natural fibres to enable the two components of the coupled sheet to be simultaneously formed.

FIGS. 4 and 5 show forming means 101 suitable for forming a sheet material 2 to obtain container shells.

The forming means 101 comprises a half-mould 103 provided with a body 104 at an active zone 113 of which an opening 105 is defined through which conduit means 110 injects fluid forming means, comprising a pressurised forming fluid arranged for deforming the sheet material 2.

The forming means 101 further comprises a further half-mould 106 provided with a further body 107 in which a cavity 13a is obtained that reproduces the form of the container shells to be obtained and which is arranged for receiving the sheet material 2 to be formed.

On the walls 13 of the cavity 13a further openings are defined 111 connected to a further conduit means 112 through which further forming fluid is aspirated to create a vacuum inside the cavity 13a.

On one face 115 of the body 104 comprising the active zone 113 of the latter membrane means 116 is associated arranged for interacting with the sheet material 2 to induce the sheet material 2 to penetrate the cavity 13a.

The membrane means 116 is made from a material that can be deformed by the action of the forming fluid, said material being impermeable to the forming fluid.

The membrane means 116 can be advantageously made of plastic material, for example of silicone or polyurethane resin.

As FIG. 8 shows, the membrane means 116 is fixed to the body 104 by frame means 117 that extends along the perimeter of the body 104. The membrane means 116 is, therefore, not anchored to the body 104 at the internal parts thereof, which contributes to increasing the deformability of the membrane means 116 during forming of the sheet material 2.

As FIG. 5 shows, in fact, when the membrane means 116 is pressed by the forming fluid, as it is not fixed to inner regions of the face 115, the material that constitutes the portion thereof that is closed between the half-mould 103 and the further half-mould 106 can be drawn towards the cavity 13a, as shown by the arrows F3, so enabling the membrane means 116 to arrange itself in contact with the walls 13, at each of their points.

This enables the sheet material 2 that is interposed between the membrane means 116 and the walls 13 to be precisely arranged according to the shape of the cavity 13a.

The membrane means 116, in the case of forming a sheet material based on plastic material, promotes excellent adhesion of the sheet material to the walls 13.

If the forming means 101 forms a sheet material with a certain porosity, for example a sheet of material based on natural fibres, the membrane means 116 acts as a barrier element to the aforesaid passage of fluid so allowing the sheet material to be formed.

At the active zone 113 of the body 104 a hollow is created 114 that has a plan form that is substantially the same as that of the cavity 13a but has a more limited depth than the latter. In this way the zone of the membrane means 116 subjected to the pressure of the forming fluid has an area that is substantially the same as the section of the cavity 13a, which enables a uniform deformation of the membrane means 116 and better forming action to be obtained.

As FIGS. 7 and 8 show, the forming means 101 can be suitable for simultaneously forming a plurality of container shells from a single film of sheet material 2.

In this case, the further body 107 is provided with a plurality of cavities 13a rather than with just one cavity.

As FIGS. 10 and 11 show, the membrane means 116 can comprise a lamina of deformable material that is provided with regions with different degrees of deformability.

Said different degrees of deformability can, for example, be obtained by making portions of lamina that have a greater thickness 127 that are placed alongside portions of lamina that have a lesser thickness 128.

Alternatively, the deformability can be controlled by inserting reinforcing fibres 129 inside the membrane means 116 to obtain reinforced portions 130 provided with greater stiffness that alternate with non-reinforced portions 131 provided with lesser stiffness.

FIGS. 7 and 8 also show the forming means 101 for the production of container shells that have the form of a trunk of a cone, wherein the bottom of the container has a section that is less than that of the mouth of the container.

In such case, in the membrane means regions with greater deformability 118 are identified that are arranged for forming the base of said container shells, and regions with lesser deformability 119 are further identified that are arranged for forming a side wall of said container shells.

In this way, during the forming phase, the bases are obtained first and then the side walls of the container shells, which enables progressive and optimal deformation of the sheet material 2 to be achieved.

The half-mould 103 and the further half-mould 106 are movable towards and away from one another in the direction of the arrows F so as to be able to be transferred from a rest position, in which the container shells obtained can be removed from the cavity 13a and a film of still undeformed sheet material 2 can be interposed between the half-mould 103 and the further half-mould 106, and a work position, in which the half-mould 103 is placed in contact with the half-mould 106 to clamp the sheet material 2.

During operation, when the half-mould 103 and the further half-mould 106 are in the work position, injection means, not shown, transfers the pressurised forming fluid into the hollow 114, through the conduit means 110. The forming fluid therefore deforms the membrane means 116 by inducing the membrane means 116 to penetrate into the cavity 13a.

The membrane means 116, in turn, causes the sheet material 2 to adhere perfectly to the walls 13.

In the meanwhile, aspirating means, not shown, extracts further pressurised fluid from inside the cavity 13a through the further conduit means 112: in this way a vacuum is created that promotes the sheet material 2 to correctly adhere to the walls 13.

Said vacuum furthermore substantially prevents wrinkles and/or folds from forming in the sheet material 2 that could lessen the quality of the formed container shells.

FIG. 6 shows a forming means 101a suitable for simultaneously forming a pair of films, or flaps of film, of sheet material 2.

The forming means 101a comprises first matrix means 120 and second matrix means 121 that are respectively provided with a first cavity 108a and a second cavity 108b suitable for receiving a sheet material 2 in the form of a first film 2a and of a second film 2b.

The forming means 101a further comprises plate means 122 cooperating with the first matrix means 120 and with the second matrix means 121 to form a pair of container shells.

The plate means 122 is defined by a first face 115a and by a second face 115b obtained in opposite zones of the plate means 122, the first face 115a being turned towards the first matrix means 120 and the second face 115b being turned towards the second matrix means 121.

The plate means 122 is traversed by inlet conduits 123 of a pressurised forming fluid, which inlet conduits, through inlet openings 125, enter into a first hollow 114a and a second hollow 114b obtained respectively at the first face 115a and the second face 115b.

The first hollow 114a faces the first cavity 108a, and the second hollow 114b faces the second cavity 108b, said first hollow 114a and second hollow 114b having an area that is substantially the same as that of the section of the first cavity 108a and of the second cavity 108b.

A first membrane 116a and a second membrane 116b are associated respectively to the first face 115a and the second face 115b of the plate means 122.

The first membrane 116a and the second membrane 116b are connected to the plate means 122 through a pair of frames 117a, 117b that extend along the perimeter of the first face 115a and of the second face 115b, in such a way that the first membrane 116a and the second membrane 116b are not fixed to the first face 115a and to the second face 115b at internal portions thereof.

During operation, the first membrane 116a and the second membrane 116b, as they are not fixed to the internal points of the first face 115a and of the second face 115b, can be subjected to significant deformations and adhere perfectly to walls 109a, 109b of the first cavity 108a and of the second cavity 108b.

The first matrix means 120 and the second matrix means 121 are traversed by removing conduits 124 that flow inside the first cavity 108a and the second cavity 108b to extract from it, through removing openings 126, the forming fluid by creating a vacuum that promotes the sheet material 2 to adhere to the walls 109a, 109b and to conform according to the shape thereof.

FIG. 9 shows the forming means 101b, comprising feeding conduit means 110 for feeding a forming fluid, said feeding conduit means 110 being defined by wall means 132, obtained at the active zone 113 of the body 104, and by the membrane means 116 associated with the active zone 113.

The conduit means 110 defines opening means 105 facing the membrane means 116 and the sheet material 2.

The forming means 101, 101a, 101b can be advantageously used to form any type of thermoformable material.

In particular, when forming a material based on plastic material, upstream the forming means 101, 101a, 101b pre-heating means is advantageously provided that heats the sheet material to a temperature that is close to softening temperature to increase deformability-of said sheet material.

Furthermore, heating means such as electrical resistances is advantageously associated to the forming means 101, 101a, 101b, which heating means further heats the sheet material 2 to enable the sheet material 2 to be formed.

When forming a material based on natural fibres, upstream the forming means 101, 101a, 101b deformability promoting means may be advantageously provided, in particular, said deformability promoting means may comprise a liquid substance, for example water, sprayed through nozzles onto the sheet material 2 in such a manner as to soften the latter and simplify deformation thereof.

To the forming means 101, 101a, 101b evacuation means can be associated that is arranged for removing the liquid substance from the sheet material once forming has terminated.

The evacuation means can advantageously comprise heating means suitable for promoting the evaporation of the liquid substance.

Further to said evaporation the sheet material regain its original stiffness in such a way that the container shells obtained therefrom are provided with good mechanical resistance.

1-75. (Canceled)

76. A forming device for forming sheet material, comprising a feeding arrangement for feeding a forming fluid suitable for forming portions of said sheet material, wherein a flow-inhibiting arrangement is further provided suitable for preventing said forming fluid from flowing through said sheet material.

77. A forming device according to claim 76, wherein said forming fluid comprises a gaseous forming fluid suitable for pneumatically forming said sheet material.

78. A forming device according to claim 76, wherein said flow-inhibiting arrangement comprises a membrane substantially impermeable to said forming fluid.

79. A forming device according to claim 78, wherein said membrane is made of plastic material.

80. A forming device according to claim 78, and further comprising a mechanical forming arrangement suitable for cooperating with said forming fluid.

81. A forming device according to claim 80, wherein said membrane wraps at least one active surface of a punch member with which said mechanical forming arrangement is provided.

82. A forming device according to claim 81, wherein said forming fluid comprises a pressurised fluid introduced into a bell member, said bell member being closed by said membrane.

83. A forming device according to claim 82, wherein said punch member is contained inside said bell member.

84. A forming device according to claim 78, and further comprising at least one body traversed by at least one conduit suitable for allowing said forming fluid to pass therethrough, said at least one conduit flowing into at least one opening arranged at a forming zone of said at least one body, said forming zone being associated to said membrane deformable by said forming fluid.

85. A forming device according to claim 84, wherein said at least one conduit is defined by walls that are entirely contained in said at least one body.

86. A forming device according to claim 84, wherein said at least one opening faces said membrane.

87. A forming device according to claim 78, wherein said membrane comprises a laminar member in which zones having different degrees of deformability are defined.

88. A forming device according to claim 87, wherein said zones comprise portions of said laminar member having a greater thickness placed alongside portions of said laminar member having a lesser thickness.

89. A forming device according to claim 87, wherein said zones comprise reinforced portions of said laminar member, that are reinforced by reinforcing fibre elements, placed alongside non-reinforced portions of said laminar member.

90. A forming device according to claim 84, wherein said at least one body comprises a first body in which said at least one opening is obtained.

91. A forming device according to claim 90, and further comprising an injecting arrangement for injecting said forming fluid into said at least one opening.

92. A forming device according to claim 90, wherein said membrane is fixed peripherally to said first body.

93. A forming device according to claim 90, wherein said at least one body comprises a further body in which at least one cavity is defined suitable for receiving said sheet material.

94. A forming device according to claim 93, wherein at least one further opening is obtained inside said at least one cavity.

95. A forming device according to claim 94, and further comprising a suction arrangement arranged to extract a further fluid from said at least one cavity through said at least one further opening.

96. A forming device according to claim 94, wherein said at least one opening is obtained in a recess facing said at least one cavity.

97. A forming device according to claim 96, wherein said recess has a plan shape that is substantially the same as the plan shape of said at least one cavity.

98. A forming device according to claim 93, wherein said first body and said further body are movable towards to, and away from, each other.

99. A forming device according to claim 76, and further comprising a heating arrangement for heating said sheet material.

100. Method for forming sheet material, comprising forming portions of said sheet material by means of a forming fluid, and further comprising interposing between said forming fluid and said sheet material a flow-inhibiting arrangement suitable for preventing said forming fluid from flowing through said sheet material.

101. Method according to claim 100, wherein said forming comprises shaping said sheet material through gaseous forming fluid.

102. Method according to claim 100, wherein said interposing a flow-inhibiting arrangement comprises interposing a membrane.

103. Method according to claim 102, wherein said forming comprises deforming said membrane through a punch member, said membrane wrapping at least an active surface of said punch member.

104. Method according to claim 103, wherein said deforming comprises delivering a pressurised fluid to a chamber member closed by said membrane.

105. Method according to claim 100, and further comprising extracting a further fluid from at least one cavity of a die arrangement, so as to make said sheet material adhere to said at least one cavity.

106. Method according to claim 100, and further comprising heating said sheet material.

107. Apparatus for forming sheet material, comprising in sequence an applying arrangement for applying onto said sheet material a deformability promoting substance suitable for making said sheet material more easily deformable and a forming arrangement suitable for deforming said sheet material.

108. Apparatus according to claim 107, wherein said applying arrangement comprises a dispensing arrangement for dispensing onto said sheet material a liquid substance.

109. Apparatus according to claim 108, wherein said liquid substance comprises water.

110. Apparatus according to claim 107, wherein said deformability promoting substance comprises additives suitable for modifying preset properties of said sheet material.

111. Apparatus according to claim 110, wherein said additives comprise stiffening substances suitable for making said sheet material stiffer.

112. Apparatus according to claim 111, wherein said stiffening substances comprise starch.

113. Apparatus according to claim 110, wherein said additives comprise substances arranged for conferring barrier properties to said sheet material.

114. Apparatus according to claim 110, wherein said additives comprise sterilizing substances suitable for sterilizing said sheet material.

115. Apparatus according to claim 107, wherein said forming arrangement comprises a mechanical forming arrangement suitable for mechanically shaping said sheet material.

116. Apparatus according to claim 107, wherein said forming arrangement comprises a fluid forming arrangement for shaping said sheet material by means of a forming fluid.

117. Apparatus according to claim 116, wherein said fluid forming arrangement comprises a pneumatic forming arrangement suitable for pneumatically shaping said sheet material.

118. Apparatus according to claim 116, and further comprising a flow-inhibiting arrangement, suitable for preventing said forming fluid from flowing through said sheet material.

119. Apparatus according to claim 118, wherein said flow-inhibiting arrangement comprises a membrane substantially impermeable to said forming fluid.

120. Apparatus according to claim 119, wherein said membrane is made of plastic material.

121. Apparatus according to claim 119, wherein said membrane comprises a laminar member in which zones having different degrees of deformability are defined.

122. Apparatus according to claim 121, wherein said zones comprise portions of said laminar member having a greater thickness placed alongside portions of said laminar member having a lesser thickness.

123. Apparatus according to claim 121, wherein said zones comprise reinforced portions of said laminar member, that are reinforced by reinforcing fibre elements, placed alongside non-reinforced portions of said laminar member.

124. Apparatus according to claim 119, wherein said membrane wraps at least one active surface of a punch member with which said forming arrangement is provided.

125. Apparatus according to claim 124, wherein said forming fluid comprises a pressurised fluid introduced into a bell member, said bell member being closed by said membrane.

126. Apparatus according to claim 125, wherein said punch member is contained inside said bell member.

127. Apparatus according to claim 115, wherein said forming arrangement comprises an extraction conduit arrangement suitable for extracting a further fluid from at least one cavity of a die member of said mechanical forming arrangement.

128. Apparatus according to claim 107, and further comprising an evacuating device for evacuating from said sheet material said deformability promoting substance.

129. Apparatus according to claim 128, wherein said evacuating device comprises a heating device for heating said sheet material.

130. Method for forming sheet material, comprising in sequence dispensing onto said sheet material a deformability promoting substance suitable for making said sheet material more easily deformable, and shaping portions of said sheet material.

131. Method according to claim 130, wherein said deformability promoting substance comprises a liquid substance.

132. Method according to claim 131, wherein said liquid substance comprises water.

133. Method according to claim 130, and further comprising applying to said sheet material additives suitable for modifying preset properties of said sheet material.

134. Method according to claim 133, wherein said additives are contained in said deformability promoting substance.

135. Method according to claim 130, wherein said shaping comprises mechanically shaping said sheet material.

136. Method according to claim 130, wherein said shaping comprises using a forming fluid.

137. Method according to claim 136, wherein said forming fluid comprises a gaseous forming fluid.

138. Method according to claim 136, and further comprising interposing between said sheet material and said forming fluid a flow-inhibiting arrangement suitable for preventing said forming fluid from flowing through said sheet material.

139. Method according to claim 138, wherein said interposing comprises interposing a membrane.

140. Method according to claim 139, wherein said shaping comprises deforming said membrane through a punch member, said membrane wrapping at least an active surface of said punch member.

141. Method according to claim 140, wherein said deforming comprises delivering a pressurised fluid to a chamber member closed by said membrane.

142. Method according to claim 136, and further comprising extracting a further fluid from at least one cavity of a die member, so as to make said sheet material adhere to said at least one cavity.

143. Method according to claim 130, and further comprising evacuating said deformability promoting substance from said sheet material, after said sheet material has been shaped.

144. Method according to claim 143, wherein said evacuating comprises heating said sheet material.

145. Method according to claim 130, and further comprising pre-heating said sheet material before said shaping so as to soften at least one layer of said sheet material.
